(19) United States
(12) Patent Application Publication
(10) Pub. No.: US 2010/0058991 A1
(43) Pub. Date: Mar. 11, 2010

(54) Aquaculture System

(75) Inventors: Philip Dobson, Dawson Settlement (CA); David Hoar, Fredricton (CA)

Correspondence Address: WARD AND SMITH, P.A., 1001 COLLEGE COURT, P.O. BOX 867, NEW BERN, NC, 28563-0867, US

(73) Assignee: AQUACULTURE ENGINEERING GROUP INC., St. Andrews, NB (CA)

(21) Appl. No.: 12/598,696

(22) PCT Filed: May 4, 2007
(86) PCT No.: PCT/CA07/00782

§ 371 Date: Nov. 3, 2009

(51) Int. Cl. A01K 61/00; A01K 97/20

(52) U.S. Cl. 119/223

(57) ABSTRACT

In the preferred embodiment there is provided an improved aquaculture system including a peripheral floatation system for suspending a containment unit in a marine environment, a peripheral weight system operatively connected to the containment unit about its lower periphery and a connection means for operatively connecting the weight system to the floatation system.

### FIELD OF THE INVENTION

The present invention is directed to an improved aquaculture system adapted for use in a marine environment, and more specifically to an improved containment unit for containing fish in a variety of conditions from protected locations to high energy wave and current conditions.

### BACKGROUND OF THE INVENTION

Fish cages or pens are known in the art and are used to contain fish or other marine life found in open waters areas, which are adapted to allow for the convenient use and access to the cage for maintenance and feeding of the fish. Cages typically may be portable but do not allow for easy movement and are adapted to be secured via multiple mooring systems. Other systems or cages exist which allow for cages to be placed in open sea conditions, however such systems are typically constructed as boats or huge rigid floats or floating systems with rigid frames which are often complex, expensive and require high levels of maintenance and user intervention for operation of the nets and feeding systems.

Generally speaking fish cages include some sort of floatation system to suspend the cage which is itself fastened to the ocean floor and include weight means to position the net in place. However, due to the wave action on the upper sections of the cage, problems have arisen.

The present system, for a single cage or multiple cage system, distinguishes over the earlier systems by virtue of a floatation collar which is not fastened to the ocean floor, but is directly connected to the weight means with a vertical tying or fastening system, and the way in which the weight means includes different sections which are articulated one to another and are themselves fastened to the ocean floor allowing the floatation collar freedom of lateral movement to compensate for movement/displacement in response to ocean wave and current action.

The present invention provides for an improved cage system having simplicity and flexibility of the design, with structural flexibility is as a primary advantage which results in considerable reduction in forces acting on the system along with the ability of the present invention to adapt to the movement of waves and fish as ocean conditions change.

### SUMMARY OF THE INVENTION

In accordance with one embodiment of the present invention, there is provided an improved aquaculture system capable of being located in a marine environment for containing fish in a variety of conditions from protected locations to high energy wave and current conditions.

A primary aspect of the present invention includes the use of a floatation “collar” or system for suspending the cage, structure including weight means at the bottom of the cage, directly connected to the floatation collar to the weights through the use of a tieing or connecting system.

One of the primary advantages of the present invention is that it is held entirely at the bottom of the cages 10 which is located below the wave action.

In accordance with one aspect of the present invention, there is provided an offshore containment system comprising: flotation means adapted to suspend an aquaculture containment unit in a marine environment; at least one containment unit including an upper and lower periphery, the unit adapted to enclose a volume of water of the marine environment and being supported by the flotation means; weight means operatively connected to the at least one containment unit about its lower periphery; and connection means adapted to connect the weight means to the flotation means and the at least one containment unit such that the connection means maintains the containment unit in a predetermined configuration.

In accordance with the above aspect, the at least one containment unit includes a net system on the upper, lower and periphery and extends between both the upper and lower periphery to completely enclose a volume of water therein.

In accordance with any of the above aspects, the flotation means is a peripheral buoyancy system adapted to support the at least one containment unit on the surface of the water. Preferably, the peripheral buoyancy system is adapted to position the unit at or near the surface of the marine environment. Desirably, the peripheral buoyancy system includes one or more sections, the sections of which may be placed about at least a portion of the upper periphery of the containment unit.

In another aspect of the present invention, there is provided an aquaculture system comprising: a fish containment unit for enclosing a volume of water, the unit including an upper portion, lower portion and peripheral wall; flotation system operatively associated with the containment unit; weight means operatively connected to the flotation means, the weight means including at least one section; and connection means for connecting the weight means to the flotation means and to the lower portion of the containment unit.

The above aspects of the present invention will become evident upon reference to the attached drawings and the following detailed description of the preferred embodiment.

### BRIEF DESCRIPTION OF THE DRAWINGS

FIG. 1 is a side view of an offshore marine containment system as provided for in accordance with a preferred embodiment of the present invention;

FIG. 2 is a top plan view of the system as provided for in FIG. 1;

FIG. 3 is a top plan view system illustrated in FIG. 1 a multiple cage to cage configuration;

FIG. 4 is a side view of the multiple cage or configuration as illustrated in FIG. 3;

FIG. 5 is an enlarged view of the floatation and mooring system of the present invention as illustrated in FIG. 1.

### DETAILED DESCRIPTION OF THE PREFERRED EMBODIMENT

In accordance with a preferred embodiment of the present invention, there is provided an improved aquaculture system or containment unit generally designated by reference numeral 10.

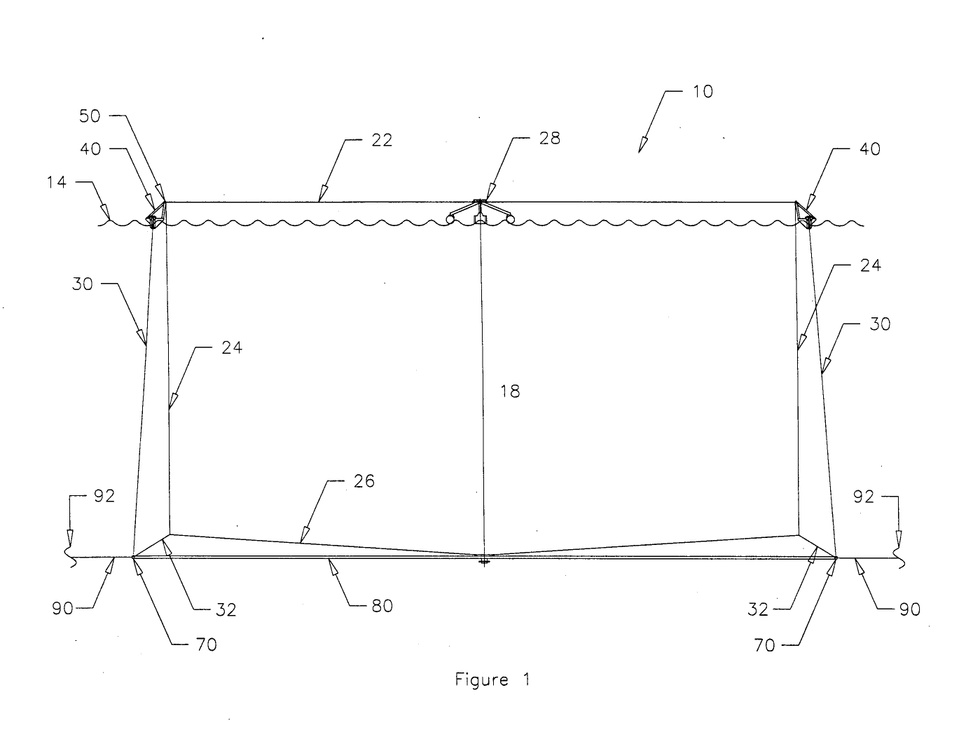

As illustrated in FIG. 1, the system or cage 10 includes the use of a net or net system 20 a volume of water defining a space 18 for containing fish or other marine life. The net 20 includes a top or upper portion 22, side walls 24 and a bottom wall 26. The net or net system may be of a one piece construction or may be formed from multiple sections of netting. A centre net support 28 and connection point for the floatation system to maintain proper shape.

The net or net system 20 is supported at the surface of the water through the peripheral buoyancy system or floatation collar 40 to which is attached the net 20 to help support the system 10 on the body of water. The majority of the cage or containment unit 10 is immersed in a body of water and only a small portion of the top section of the containment unit 10 is above the surface 14 of the water. As illustrated, the floatation collar or peripheral buoyancy system 40 are attached to a weight ring system (discussed in greater detail hereinbelow) via fixed or flexible connecting members (such as cables, ropes or lines) generally indicated by reference numeral 30, and to the net or net system 20 by fixed or flexible members 32 to maintain the required net enclosure shape.

As illustrated, the net system 20 used in the present cage or containment system 10 may be a conventional net system 20 which encloses the top, bottom and peripheral or side of the cage and is maintained in place by the peripheral buoyancy system and peripheral weight system at the top and bottom of the structure. In a preferred embodiment, the peripheral rail 50 is used to attach at least a portion of the net via suitable means. The net system 20 is able to then be completely secured with a suitable tieing or closure system in the center of the net 10 or containment system.

The containment unit 10 is supported at the surface by a peripheral buoyancy system that may be adapted to position at or near the surface 14.

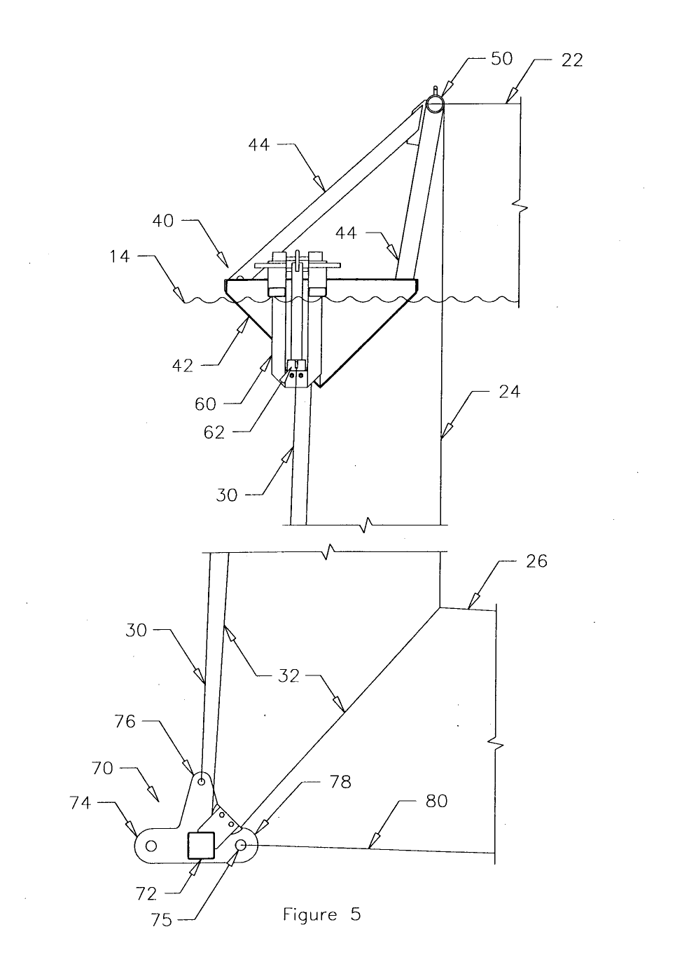

The peripheral buoyancy system 40 along with the peripheral weight system 70 is shown in greater detail in FIG. 5. With respect to the peripheral buoyancy system 40, the system includes a float collar identified by reference 42, which is adapted to be positioned at or near the surface of the water 14.

As illustrated, floatation system 40 includes an independent or stand alone buoyancy member(s) 42 to which are attached rails or braces 44, which extend and attach to a peripheral rail generally identified by numeral 50 positioned above the buoyancy member 42. As contemplated, the peripheral rail 50 extends about the periphery of the containment unit 10 and provides an attachment to which the net or net system 24 may be supported near the top of the unit.

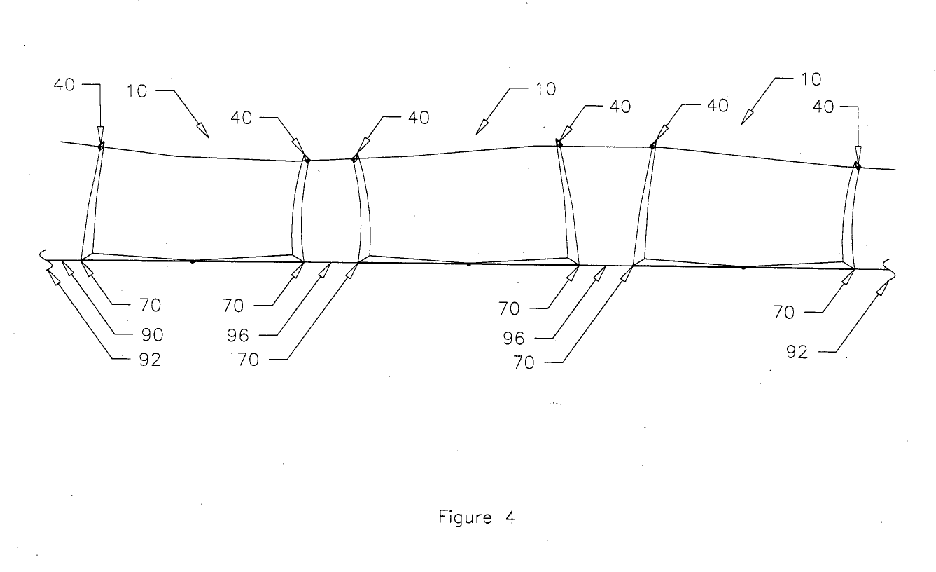

As illustrated in FIG. 4, the system components 40 above the lower weight system 70 can react in a controlled manner to the water surface environmentally induced wave and current influences. The connection system (40 and 70) of the present invention allows reduced energy loading on exposed upper enclosure elements and reduced energy on interconnections or mooring systems.

Attached to the peripheral buoyancy or floatation system 40 is an adjustable cable securing means or device identified by reference numeral 60. Preferably, the cable securing means 60 includes a pulley or other similar or conventional means generally indicated by reference numeral 62 to adjust cable or flexible connecting element 30 attached to the peripheral weight system in order to adjust and/or maintain the shape of the net or net system 20. Such other similar or conventional systems may include, but are not limited to, ring, loop or enclosed groove to allow the net tensioning line to slide freely and maintain tension with minimal chafing once the net system is properly shaped and tensioned.

As illustrated, the floatation collar 40 is attached to the weight/grid located at or below the bottom of the cages by a system of ropes or cables 30 which give the collar 40 the ability or freedom to move in concert with the back and forth motion of the waves, thereby relieving the stress of trying to fight the waves by allowing the floatation to move back and forth with these wave motions.

The floatation collar 40 may be a continuous plastic collar, or may be sectional. Preferred materials include metal, plastic or wood or other conventional or suitable material known in the art. In an alternative embodiment, the weight system 70 may be in the form of articulating sections, or it may be a flexible collar (for example as identified by reference numeral 72) filled with a suitable weighting substance. Desirably, the weight 72 is sufficiently rigid to hold its shape when anchoring forces are applied. As illustrated, the floatation means 40 may be single or separate individual sections, although the use of different sections encompassing the upper portion of the cage could be articulated in one embodiment.

As illustrated in FIG. 5, and attached to the adjustable cable securing means 60 through cable or flexible element 30 is the peripheral weight system generally identified by reference numeral 70. The lower peripheral weight system(s) 70 are configured as enclosure system connection points allowing system components 40 above the said peripheral lower weight system to move unhindered other than to the aforesaid vertical connection devices.

As illustrated, the peripheral weight system 70 includes a weight identified by reference numeral 72 and connection points 74, 76 and 78. As illustrated, connection points 74, 76 and 78 may include apertures or other similar means adapted to serve as interconnection points to other similar enclosure systems via fixed or flexible connecting elements to maintain a consistent relationship between these enclosures. Further, connection points, for example 74, may be configured to serve as a mooring connection on single or multiple enclosure systems. As noted above, cable securing means 60 is attached to the weight system 70 via connection point 76. Connection point 78 is adapted or configured in combination with a system of cross connected cables or elements 80 to assist in maintaining the predetermined shape of the weight system.

As illustrated in FIG. 5, there is provided an attachment point 74 of the weight system 70 which may be attached to additional cages or to a mooring line 90 to provide an anchor point 92 to the bottom. This anchor point 92 would allow cages 10 attached at the weight ring 70 rather than at the surface to provide a much shorter anchor and as such, have a smaller foot print on the ocean bottom.

Further, such an anchor attachment at the bottom of the weight ring will reduce stress at the top of the structure.

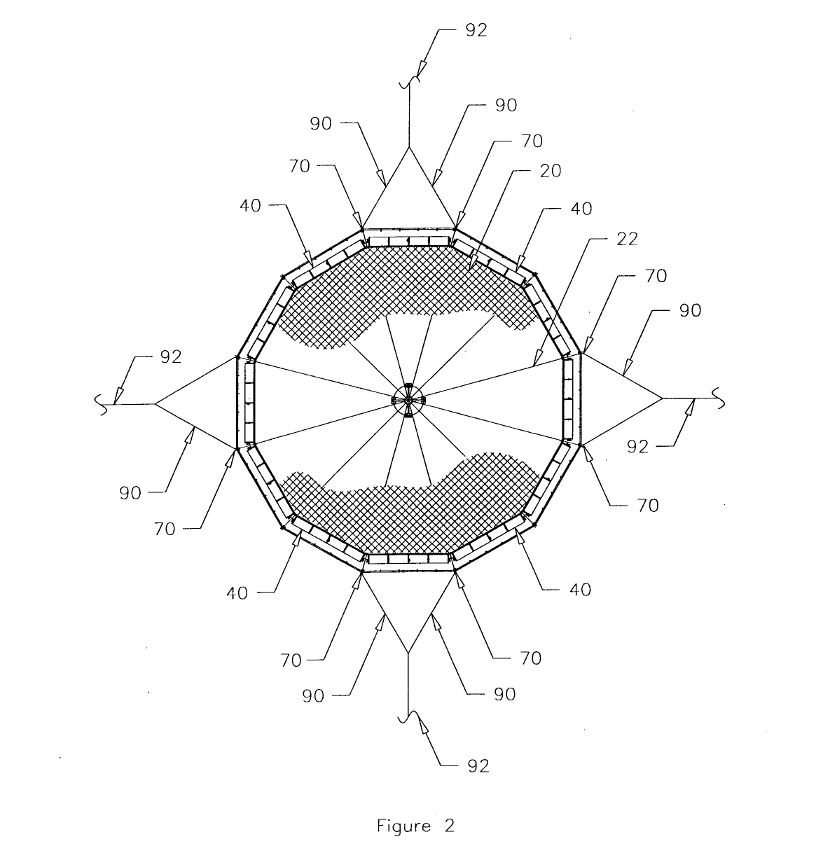

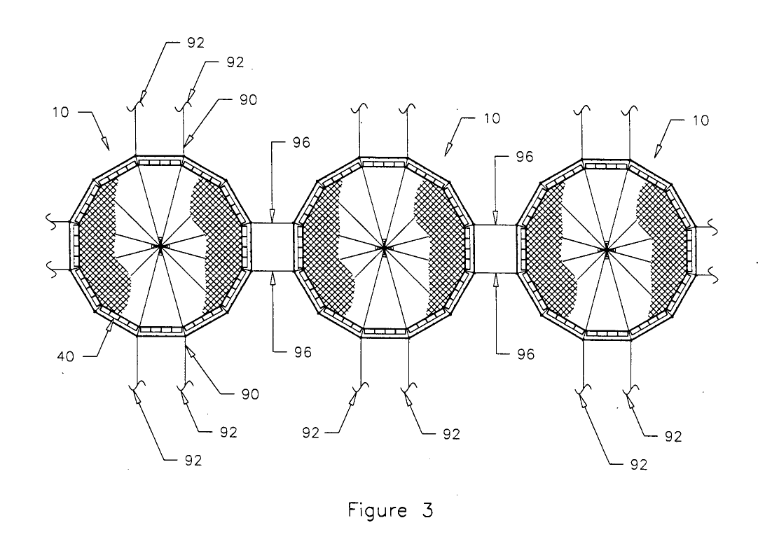

As illustrated in FIGS. 2, 3 and 4, the connection provisions 74 of the weight system 70 may also be used to serve as an interconnection point to other similar units 10 through suitable fixed or flexible connecting elements 96.

As illustrated in FIG. 5, the weight system 70 in the preferred embodiment includes several individual sections connected together via flexible or hinge connections which allow for flexing in a vertical direction to accommodate forces from surface waves and current transmitted from the surface peripheral buoyancy system 40.

This also allows the fish, which are a part of the wave and move with it, the ability or freedom to move without being irritated or caught by the sides of the nets which now also move with the wave, water, and the fish. This makes the relative position of fish, water, and wave close to the same thereby reducing stress on the fish and the equipment.

The number of cages or units 10 in a grid can be one or multiple units. A single cage would be fastened at the weight ring/grid located below or at the bottom of the cage at one location (in which case it would swing), or at many places in order to have its position fixed relative to the bottom of the ocean. Cages 10 may also be strung in a line that swings or fixed in a grid pattern, which may be any pattern or rows as desired. An advantage to such an array is the saving in anchors by grouping cages, although it may be desirable to anchor cages further apart. Other patterns, such as in a circle or some other suitable pattern, will also facilitate in disease control or feeding systems.

In a further embodiment, the weight system 70 may be made up of a plurality of sections surrounding the unit 10 with adjoining or adjacent sections being interconnected to permit each section to move independently of the other.

A further advantage of the present invention is the provision of the anchor attachment (90 and 92) at the bottom of the unit 10 thereby reducing stress at the top and further reducing the site footprint.

It will be understood by those of skill in the art to which the present invention relates that the above described preferred embodiments are merely exemplary and are not intended to limit the scope of the present invention as claimed.

1. An offshore containment system comprising:
flotation means adapted to suspend an aquaculture containment unit in a marine environment;
at least one containment unit including an upper and lower periphery, said unit adapted to enclose a volume of water of said marine environment and being supported by said flotation means;
weight means operatively connected to said at least one containment unit about its lower periphery; and
connection means adapted to connect the weight means to said flotation means and said at least one containment unit such that the connection means maintains the containment unit in a predetermined configuration.

2. The containment system according to claim 1, wherein the at least one containment unit includes a net system on the upper and lower periphery and extends between both said upper and lower periphery to completely enclose a volume of water therein.

3. The containment system according to claim 1 or 2, wherein the flotation means is a peripheral buoyancy system adapted to support the at least one containment unit on the surface of the water.

4. The containment system according to claim 3, wherein the peripheral buoyancy system is adapted to position the unit at or near the surface of said marine environment.

5. The containment system according to claim 3, wherein said peripheral buoyancy system includes one or more sections which may be placed about one or more portions of the upper periphery of the at least one containment unit.

6. An aquaculture system comprising: a fish containment unit for enclosing a volume of water, the unit including
an upper portion, lower portion and peripheral wall;
flotation means operatively associated with said containment unit;
weight means operatively connected to the flotation means, said weight means including at least one section; and
connection means for connecting the weight means to said flotation means and to the lower portion of the containment unit.

7. The system according to claim 6, wherein the flotation means extends about at least a portion of the upper periphery of the containment unit.

8. The system according to claim 6, wherein the weight system includes one or more sections adapted to be connected together and spaced about the periphery of the lower portion of the containment unit.
